(19) United States
(12) Patent Application Publication
(10) Pub. No.: US 2024/0045167 A1
(43) Pub. Date: Feb. 8, 2024

(54) SYSTEMS FOR ATTACHING OVERLAYS TO ELECTRONIC DISPLAYS

(71) Applicant: 3M INNOVATIVE PROPERTIES COMPANY, St. Paul, MN (US)

(72) Inventors: Steven T. Swartz, Pepperell, MA (US); Giuseppe De Bellis, 16 Merrimac Drive (IT); David S. Owen, Woodbury, MN (US); Catherine A.C. Jameson, Providence, RI (US); Gregor Mittersinker, Providence, RI (US); Christopher J. O'Connell, Boston, MA (US)

(21) Appl. No.: 18/265,590

(22) PCT Filed: Dec. 9, 2021
(86) PCT No.: PCT/IB2021/061512

§ 371 Date: Jun. 6, 2023

Related U.S. Application Data
(60) Provisional application No. 63/128,592, filed on Dec. 21, 2020.

(51) Int. Cl. G02B 7/00

(52) U.S. Cl. CPC G02B 7/006; G02B 2207/123

(57) ABSTRACT

A system for attaching overlays to an electronic display comprises (a) at least one bracket defined by an outer face and an inner face and (b) at least one second attracting member comprising a layer of pressure sensitive adhesive. The bracket has an L-shaped cross-section comprising a first leg and a second leg. The inner face of the first leg comprises a first attracting member and the inner face of the second leg comprises a layer of pressure sensitive adhesive.

### FIELD

This invention relates to systems for attaching overlays to electronic displays.

### BACKGROUND

Electronic displays for devices such as laptop or desktop computers are sometimes equipped with a light control filter or other overlay to provide features such as enhanced privacy, glare reduction or antireflection, polarization, diffusion, tint, electromagnetic shielding, scratch or smudge resistance, slipperiness or touch sensitivity. A variety of mechanical mounts and other measures have been used to fasten such overlays to a display device. For example, overlays such as privacy filters have been mounted on a display via a sets of plastic tabs having an adhesive stripe on one side of each tab. The plastic tabs are adhered to the side edges of the display bezel, e.g., near each corner of the display, with a portion of each plastic tab projecting inward over the front of the display. The privacy filter can be slid between the plastic tabs and the front of the display and removed when privacy is not needed.

### SUMMARY

We recognize that there is a need is the art for improved systems for attaching overlays to electronic displays. The design trend in displays, especially in desktop displays, is for bezel-less displays with no raised perimeter and very narrow borders. Thus, it is difficult to mount tabs or other traditional attachment systems on the display bezel or border. There is also not enough space to slide an overlay behind plastic tabs because of the lack of a raised perimeter.

In addition, we recognize that there is a desire for attachment systems that do not obstruct the viewing area of the display.

Briefly, in one aspect, the present invention provides a system for attaching overlays to an electronic display. The system comprises at (a) least one bracket defined by an outer face and an inner face, the bracket having an L-shaped cross section comprising a first leg and a second leg, wherein the inner face of the first leg comprises a first attracting member and the inner face of the second leg comprises a first layer of pressure sensitive adhesive and (b) at least one second attracting member comprising a second layer of pressure sensitive adhesive.

In another aspect, the present invention provides another system for attaching overlays to an electronic display. The system comprises a display overlay and at least one straight bracket. The bracket is defined by a first major surface and a second major surface, wherein the second surface comprises a magnet in an upper half of the second surface and a first layer of pressure sensitive adhesive in a lower half of the second surface. The first layer of pressure sensitive is attached to the top of the front major surface of the display overlay.

The systems of the present invention facilitate easy removal and installation of overlays to electronic displays having little to no bezel. In addition, the systems can be designed so that they do not obstruct the viewing area of the display.

### BRIEF DESCRIPTION OF THE DRAWINGS

FIG. 1A is a sideview of a bracket of the invention.

FIG. 1B is a sideview of another bracket of the invention.

FIG. 1C is a perspective view of the bracket of FIG. 1A.

FIG. 2 is a perspective view of an attachment system of the invention.

FIG. 3A is a perspective view of an attachment system of the invention as used.

FIG. 3B is a side view of an attachment system in use.

FIG. 4 is a sideview of a bracket of the invention.

### DETAILED DESCRIPTION

The attachment systems of the present invention provide an easy, user-friendly means for consumers to repeatedly attach, remove and reattach an overlay to a display device.

Various overlays are known in the art and are can be attached to displays using the systems of the invention. Light control films or other overlays can provide features such as enhanced privacy, glare reduction or antireflection, polarization, diffusion, tint, electromagnetic shielding, scratch or smudge resistance, slipperiness or touch sensitivity.

A light control film (LCF) (also known as a light collimating film) is an optical film that is configured to adjust the directivity of transmitted light. Various LCF systems are known, and typically comprise a light transmissive film having a plurality of parallel grooves, wherein the grooves are comprised of a light absorbing material. Depending on the orientation of the grooves, the spacing, and the geometry of the grooves (e.g., sidewall angles), the LCF can provide maximum transmission and provide image cutoff or black along known polar coordinates at a predetermined angle of incidence relative to the image plane for utilization as a privacy filter.

The LCF can be placed adjacent to the display surface. Typically, the LCFs are designed such that they are visible at normal incidence (i.e., at a 0 deg. viewing angle when the viewer is viewing the image through the LCF perpendicular to the film surface and image plane). As the viewing angle increases, the amount of light transmitted through the LCF decreases until the observed cut-off angle is reached, wherein substantially all of the light is blocked by the light absorbing material and the image is no longer visible. When used as a so-called privacy filter (e.g., for a liquid crystal display in a computer monitor or a laptop display), this feature of the LCF can prevent viewing by an observer outside the typical viewing angle. Thus, privacy is provided to the viewer.

The attachment systems of the invention include at least one bracket comprising an attracting member and a layer of pressure sensitive adhesive. The attracting member attaches to the top horizonal edge of the display device directly or to a second attracting member adhered to the top horizonal edge of the display. The layer of pressure sensitive adhesive adheres the bracket to the overlay.

The bracket can be made of any useful material such as, e.g., plastic or metal. Examples of suitable plastics include acrylic, acrylonitrile butadiene styrene (ABS), polycarbonate, polyethylene terephthalate (PET), polyethylene, Nylon, polystyrene, Delrin™ plastic and thermoplastic polyurethane (TPU). Examples of suitable metals include aluminum and steel. In some embodiments, a plastic bracket is made using injection molding.

The bracket can be clear or opaque. It can be any color or have any decorative design. In some embodiments, the bracket is clear so that is does not distract the display user or obstruct any of the viewing area of the display. Suitable clear plastics include, e.g., acrylic, ABS, polycarbonate and PET.

In some embodiments of the invention, the bracket attaches directly to the display. In other embodiments, the attachment system further comprises a second attracting member comprising a layer of pressure sensitive adhesive that can adhere the second attracting member to the display. In this embodiment, the first attracting member of the bracket attaches to the second attracting member, which is adhered to the display.

The attracting members may comprise any suitable attracting means that connect easily and hold in place such as, e.g., magnets, hook and loop fasteners, 3M Dual Lock™ fasteners, dry “gecko” adhesives and the like. In some embodiments, the attracting members comprise magnets with different magnetic poles or, alternatively, one may comprise a magnet and the other may comprise a ferromagnetic material such that the two attracting members are attracted to each other. Examples of suitable magnets for attracting members include permanent magnets such as ferrites (ceramic-like material made from a mix of iron oxides with nickel, strontium or cobalt), Alnico (an alloy of aluminum, nickel and cobalt) or rare-earth magnets. Rare-earth magnets are very strong magnets and are difficult to demagnetize. Thus, in some embodiments of the invention, rare earth magnets are preferred because a much smaller and compact magnet can be utilized. Examples of rare-earth magnets include, e.g., neodymium iron boron (NdFeB) and samarium cobalt (SmCo). Examples of suitable ferromagnetic materials include Fe, Ni, Co, or any metal materials attractable to magnetic force.

The pressure sensitive adhesive (PSA) layer(s) can comprise any useful pressure sensitive adhesive. Any useful PSA can be utilized. Examples of useful PSAs include acrylic laminating adhesives such as 3M™ 468MP and 3M™ 9472LE available from 3M Company, St. Paul, MN.

In some embodiments, the pressure sensitive adhesive layer comprises an optically clear pressure sensitive adhesive. It can be preferred that an optically clear pressure sensitive adhesive (OCA) is utilized on the bracket when the bracket comprises a clear material. Any useful OCA can be utilized. Examples of suitable OCAs include 3M™ 8146 and 3M™ 8172 available from 3M Company.

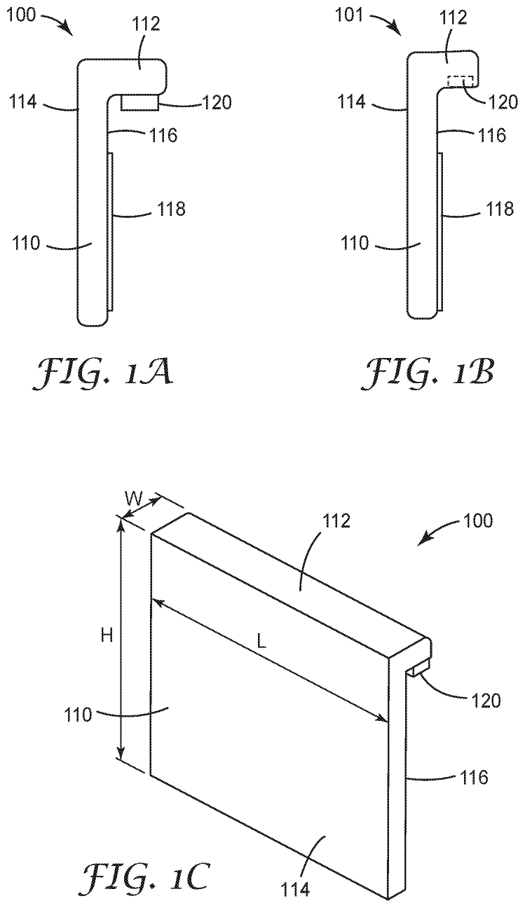

In one embodiment of the invention, the bracket has an L-shaped cross-section. As shown in FIG. 1A, bracket 100 is defined by outer face 114 and inner face 116, and includes a first leg 110 and a second leg 112. Inner face 116 of second leg 112 includes pressure sensitive adhesive layer 118. First attracting member 120 is attached to the surface of inner face 116 of first leg 110. The bracket may have smooth, straight, rounded or curved edges or any combination thereof as long as it has a generally L-shaped cross-section. As-used herein, the term “L-shaped” means having the general shape of the capital letter L. In the present invention, the legs of the bracket join at an angle that may be a right angle or may vary from a right angle by +/−2 degrees, 5 degrees, 10 degrees, 20 degrees or 30 degrees.

Alternatively, first attracting member 120 may be embedded (or partially embedded) in first leg 110 as shown in the sideview of bracket 101 in FIG. 1B. Embedding the first attracting member into the first leg may be preferred when the first attracting member is small, particularly when first attracting member comprises a rare-earth magnet. When the bracket is made by injection molding and the first attracting member is a rare-earth magnet, it can be preferred to place the magnetizable material in the mold, carry out the injection molding process and then magnetize the material due to the temperature sensitivity of rare-earth magnets. Alternatively, a bracket with a cavity for the magnet may be injection molded. The (magnetized) magnet can then be placed in the cavity and then encapsulated, e.g., with a cover.

FIG. 1C shows a perspective view of bracket 100 wherein its longitudinal dimension of can be observed. Bracket 100 has length L, width W (which is also the length of the first leg) and height H (which is also the length of the second leg).

Brackets of the invention may have any useful dimensions. In some embodiments, width W (length of the first leg) is less than height H (length of the second leg). In some embodiments, length L is up to 120 mm or 150 mm when one bracket is utilized. Length L is typically at least about 60 mm if two or more brackets are used. Length L can be customized to correspond to the to the bezel width of the display. In some embodiments, width W (length of the first leg) is at least about 5 mm or at least about 10 mm. Width W can be customized according to the depth of the display. In some embodiments, height H (length of the second leg) is from about 4 mm to about 20 mm, or from about 5 mm to about 16 mm.

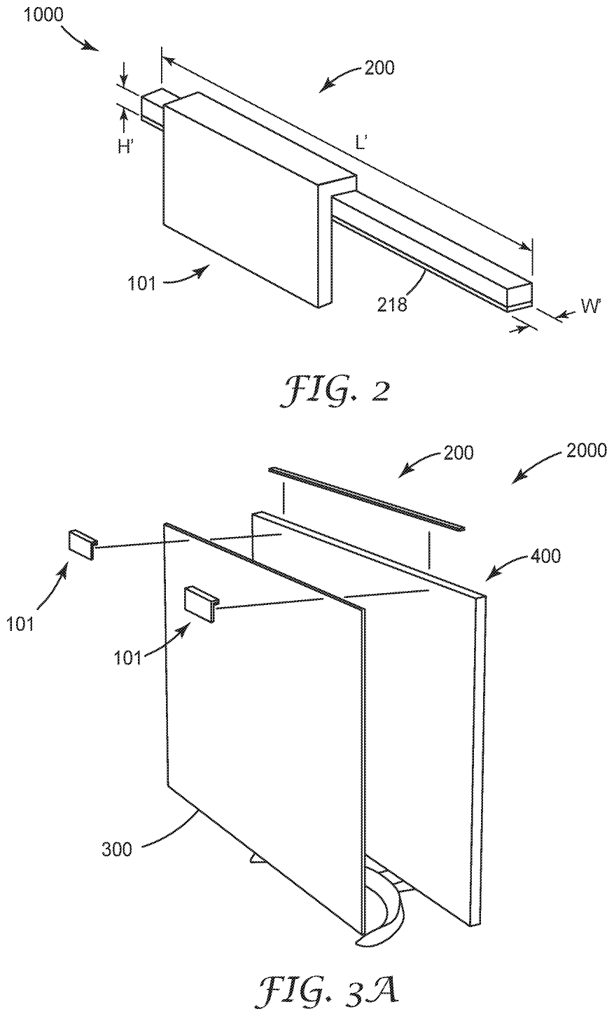

Bracket 101 can be provided with a second attracting member as an attachment system. Attachment system 1000, shown in FIG. 2, includes, bracket 101 and bar-shaped second attracting member 200. Second attracting member 200 includes pressure sensitive adhesive layer 218, which is utilized to attach it to the display.

An attachment system may include, e.g., one bracket and one second attracting member, two or more brackets and one second attracting member, two or more brackets and two or more second attracting members or any other useful combination. The one or more second attracting members can have any useful shape. For example, they may be cuboid, cube, cylindrical or the like. Preferably they have at least one flat face on which the pressure sensitive adhesive is laminated. In some embodiments, the second attracting member has a length L′ of about 60 mm to about 120 mm, a width W′ of about 5 mm to about 20 mm, or about 10 mm to about 15 mm, and height H′ of about 10 mm to about 20 mm, or about 15 mm to about 18 mm. Length L′ can be as long as the length of the entire display to which it is attached.

One preferred attachment system includes two brackets having L-shaped cross-sections with rare-earth magnets and one or two bar-shaped second attracting members comprising metal. In some embodiments, two brackets and two bar-shaped attracting members and are preferred

An attachment system may be provided to a user with release liners protecting the pressure sensitive adhesive layers until use.

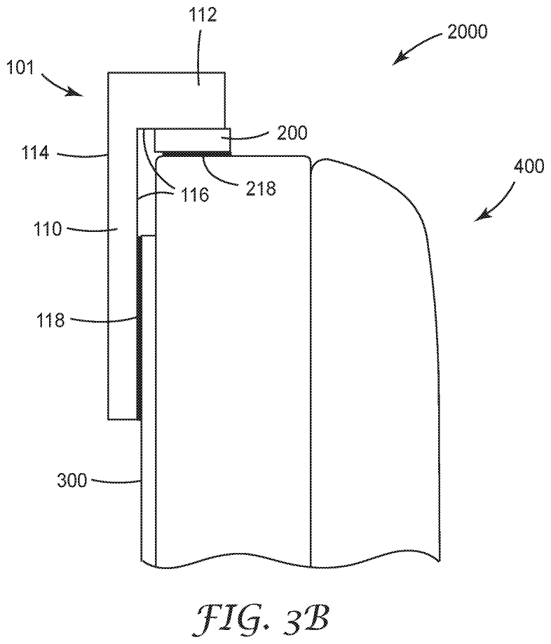

The attachment system can be utilized to attach an overlay to a display. For example, in FIGS. 3A and 3B, attachment system 2000 has two brackets 101 and one bar-shaped second attracting member 200. In other embodiments, two shorter bar-shaped attracting members may be utilized. Pressure sensitive adhesive layer 118 is used to adhere brackets 100 to the front surface (viewer's side) of the top of overlay/privacy filter 300. Pressure sensitive adhesive layer 218 is used to adhere bar-shaped second attracting member 200 to the top horizontal edge of desktop display 400. First attracting member 120 (e.g., a rare-earth magnet) on brackets 101 can be connected to bar-shaped second attracting member 200 (e.g., a metal bar) to attach privacy filter 300 to desktop display 400 as shown close up in FIG. 3B. First attracting member 120 is attracted by magnetic force to automatically align with second attracting member 200, thereby automatically positioning privacy filter 300. Attachment system 2000 holds privacy filter 300 close to display 400, minimizing the airgap between the filter and display and thus reducing any image distortion or ghosting. The overlay/privacy filter can be easily removed and then reattached as needed. A user may attach and/or remove the overlay/filter touching only the brackets, avoiding unwanted fingerprints on the overlay/filter.

The attachment system illustrated in FIGS. 3A and 3B are configured to attach the top edge of the overly to the top edge of the display. In other embodiments, the system may be utilized for attachment at any one or more edges.

In some attachment systems of the invention, a second attracting member is not necessary. For example, one or more brackets comprising a magnet may be attached directly to the top horizonal edge of a display if the edge comprises ferromagnetic material.

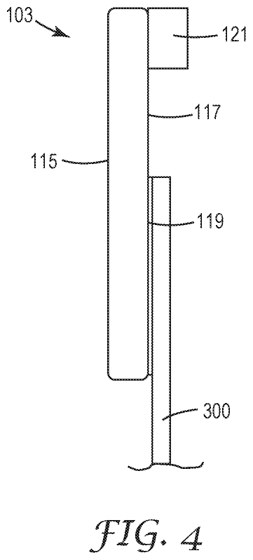

In another embodiment of the invention, an attachment system comprises at least one straight bracket and a display overlay. As illustrated in FIG. 4, straight bracket 103 is defined by first major surface 115 and second major surface 117, which comprises first attracting member or magnet 121 in an upper half of the second major surface and first layer of pressure sensitive adhesive 119 in a lower half of the second major surface attached to the top of the front major surface of display overlay 300. Attachment systems comprising a straight bracket can be utilized in similar manner to systems comprising a bracket having an L-shaped cross-section; however, the magnet attaches to the front face of the top horizontal edge of a display, wherein the edge comprises ferromagnetic material.

Straight brackets may have smooth, straight, rounded or curved edges or any combination thereof. The length and height of straight brackets may have dimensions similar to the brackets having an L-shaped cross-section described above. The same materials may also be utilized.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A system for attaching overlays to an electronic display comprising:
(a) at least one bracket defined by an outer face and an inner face, the bracket having an L-shaped cross section comprising a first leg and a second leg, wherein the inner face of the first leg comprises a first attracting member and the inner face of the second leg comprises a first layer of pressure sensitive adhesive; and
(b) at least one second attracting member comprising a second layer of pressure sensitive adhesive.

2. The system of claim 1 wherein at least one of the first attracting member and the second attracting member comprises a magnet.

3. The system of claim 2 wherein at least one of the first attracting member and second attracting member comprises a rare-earth magnet.

4. The system of claim 2 wherein one of the first attracting member and the second attracting member comprises ferromagnetic material.

5. The system of claim 1 wherein the first attacking member comprises a rare-earth magnet and the second attracting member comprises ferromagnetic material.

6. The system of claim 1 wherein the bracket comprises plastic.

7. The system of claim 6 wherein the bracket comprises clear plastic.

8. (canceled)

9. The system of claim 1 wherein the length of the first leg is less than the length of the second leg.

10. The system of claim 1 wherein the length of the second leg corresponds to the bezel width of a display on which the system will be utilized.

11. The system of claim 1 wherein the second attracting member is bar-shaped.

12. The system of claim 1 wherein the first attracting member is at least partially embedded in the first leg.

13. The system of claim 1 comprising two brackets.

14. The system of claim 1 further comprising a display overlay.

15. The system of claim 14 wherein the display overlay is a protective film or a privacy film.

16. The system of claim 14 wherein the second adhesive layer is adhered to the front major surface of the display overlay, and wherein the second adhesive layer is adhered to the top of the front major surface of the display overlay.

17. (canceled)

18. The system of claim 1 wherein the second attracting member is adhered to an edge of a display, and wherein the edge of the display is the top horizontal edge of the display.

19. (canceled)

20. The system of claim 19 wherein the first attracting member is attached to the second attracting member such that the back major surface of the display overlay is adjacent the viewing area of the display.

21. The system of claim 19 wherein the display is a desktop display.

22. A system for attaching overlays to an electronic display comprising a display overlay and at least one straight bracket, the bracket defined by a first major surface and a second major surface, wherein the second surface comprises a magnet in an upper half of the second surface and a first layer of pressure sensitive adhesive in a lower half of the second surface; and wherein the first layer of pressure sensitive is attached to the top of the front major surface of the display overlay.

23. The system of claim 22 wherein the magnet is attached to the front face of the top horizontal edge of a display, wherein the edge comprises ferromagnetic material.
